(19) United States
(12) Patent Application Publication
(10) Pub. No.: US 2024/0142772 A1
(43) Pub. Date: May 2, 2024

(54) LENS CAP FOR AN OPTICAL DEVICE

(71) Applicants: Kilian Theodor Liptrot, Washington, DC (US); David Mayne Strout, Washington, DC (US)

(72) Inventors: Kilian Theodor Liptrot, Washington, DC (US); David Mayne Strout, Washington, DC (US)

(21) Appl. No.: 18/491,839

(22) Filed: Oct. 23, 2023

Related U.S. Application Data
(60) Provisional application No. 63/381,990, filed on Nov. 2, 2022.

(51) Int. Cl. G02B 27/00; G02B 23/16; G03B 11/04

(52) U.S. Cl. CPC G02B 27/0006; G02B 23/16; G03B 11/043

(57) ABSTRACT

A lens cover, including: a plurality of flexible membranes; a plurality of struts, wherein each strut is coupled to a respective flexible membrane of the plurality of membranes; and a rotatable actuating ring for rotatably displacing the plurality of struts to expand or contract the plurality of flexible membranes to selectively cover or expose a lens of an optical device.

### TECHNICAL FIELD

The present invention relates to the field of optical devices and, more particularly, to a lens cover for an optical device. The lens cover includes a rotatable actuating ring for expanding or contracting a plurality of flexible membranes to selectively cover or expose a lens of the optical device, without having to physically attach or detach the lens cover to/from the lens of the optical device.

### BACKGROUND

Lenses in optical devices used in photography, videography, hunting, astronomy, and other fields are commonly protected by a lens cover. Such optical devices may include, for example, film and digital cameras, video cameras, telescopic scopes, telescopes, etc. A lens cover commonly attaches onto the end of a lens of an optical device and must be removed from the lens before the optical device can be used. After the optical device is used, the lens cover must be retrieved from wherever it was placed and reattached to the lens in order to protect the lens from damage. Unfortunately, once removed from the lens, a lens cover is easily misplaced or lost.

In some cases, a lens cover may be attached to an optical device with a tether. However, when removed from a lens, a dangling lens cover may interfere with the operation of the optical device or may become tangled with other items such as a carrying strap.

### SUMMARY

Accordingly, embodiments of the present disclosure are directed to a lens cover with a rotatable actuating ring for expanding or contracting a plurality of flexible membranes to selectively cover or expose a lens of an optical device, without having to physically attach or detach the lens cover from the lens of the optical device. Once secured on the lens of an optical device, the rotatable actuating ring may be rotated in a first direction to expand the flexible membranes over the lens to fully cover the lens (fully closed state), or rotated in a second, opposite direction to contract the flexible membranes to fully expose the lens (fully open state). When in the fully open state, the lens cover does not interfere with the operation of the lens or optical device. Advantageously, once the lens cover is installed on the lens, it may never or rarely have to be removed, thereby preventing the lens cover from being misplaced or lost.

A first aspect of the disclosure is directed to a lens cover, including: a plurality of flexible membranes; a plurality of struts, wherein each strut is coupled to a respective flexible membrane of the plurality of membranes; and a rotatable actuating ring for rotatably displacing the plurality of struts to expand or contract the plurality of flexible membranes to selectively cover or expose a lens of an optical device.

A second aspect of the disclosure is directed to an optical device, including: a lens; and a lens cover, wherein the lens cover includes: a plurality of flexible membranes; a plurality of struts, wherein each strut is coupled to a respective flexible membrane of the plurality of membranes; and a rotatable actuating ring for rotatably displacing the plurality of struts to expand or contract the plurality of flexible membranes to selectively cover or expose the lens of the optical device.

### BRIEF DESCRIPTION OF THE DRAWINGS

The numerous advantages of the present disclosure may be better understood by those skilled in the art by reference to the accompanying figures.

FIG. 1 depicts a plan view of a lens cover in a fully open state according to embodiments of the disclosure.

FIG. 2 depicts a perspective view of a lens cover in a fully open state according to embodiments of the disclosure.

FIG. 3 depicts a plan view of a lens cover in a transitional state (e.g., partially opened/closed) according to embodiments of the disclosure.

FIG. 4 depicts a perspective view of a lens cover in a transitional state according to embodiments of the disclosure.

FIG. 5 depicts a plan view of a lens cover in a fully closed state according to embodiments of the disclosure.

FIG. 6 depicts a perspective view of a lens cover in a fully closed state according to embodiments of the disclosure.

FIG. 7 depicts a plan view of a base of a lens cover according to embodiments of the disclosure.

FIG. 8 depicts an enlarged plan view of a flexible membrane and strut of a lens cover according to embodiments of the disclosure.

FIG. 9 depicts an enlarged perspective view of a flexible membrane according to embodiments of the disclosure.

FIG. 10 depicts a cross-sectional view of an attachment of the rotatable actuation ring to the base of the lens cover to embodiments of the invention.

FIG. 11 depicts an attachment of the lens cover to an optical device according to embodiments of the invention.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

Several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

According to embodiments of the disclosure, there is provided a lens cover with a rotatable actuating ring for expanding or contracting a plurality of flexible membranes to selectively cover or expose a lens of an optical device, without having to physically attach or detach the lens cover from the lens of the optical device. The lens cover is secured to an end of the lens (e.g., to a distal end of a barrel of the lens). Once secured on the lens, the rotatable actuating ring may be rotated in a first direction to expand the flexible membranes over the lens to fully cover the lens (fully closed state), or rotated in a second, opposite direction to contract the flexible membranes to fully expose the lens (fully open state). When in the fully open state, the lens cover does not interfere with the operation of the lens or optical device. Advantageously, once the lens cover is installed on the lens, it may never or rarely have to be removed, thereby preventing the lens cover from being misplaced or lost.

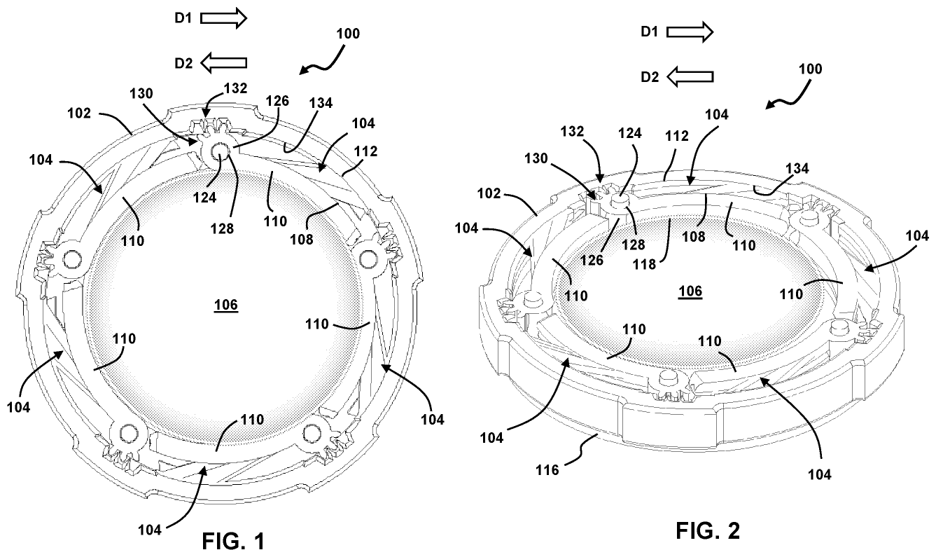

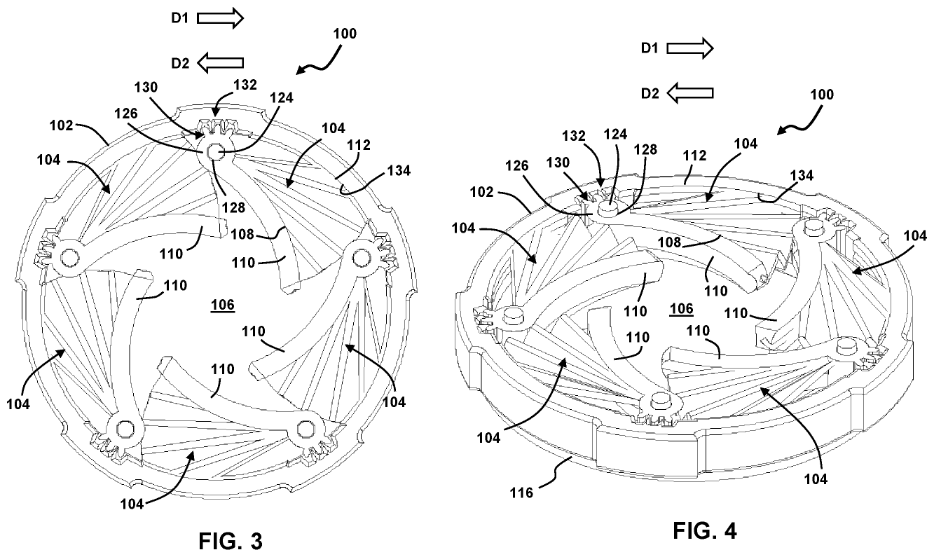

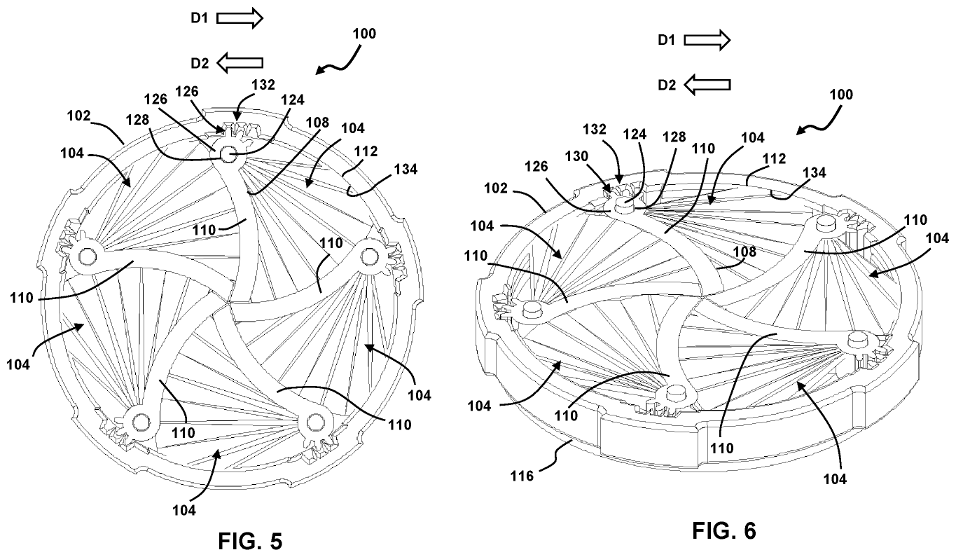

A plan view of a lens cover 100 in a fully open state according to embodiments of the disclosure is depicted in FIG. 1. A corresponding perspective view of the lens cover 100 in the fully open state is depicted in FIG. 2. A plan view of the lens cover 100 in a transitional state (e.g., partially open/closed) according to embodiments of the disclosure is depicted in FIG. 3. A corresponding perspective view of the lens cover 100 in the transitional state is depicted in FIG. 4. A plan view of the lens cover 100 in a fully closed state according to embodiments of the disclosure is depicted in FIG. 5. A corresponding perspective view of the lens cover 100 in the fully closed state is depicted in FIG. 6. As will be described in greater detail herein, the lens cover 100 is configured to selectively cover and uncover a lens of an optical device without having to physically attach or detach the lens cover 100 to/from the lens of the optical device.

According to embodiments, the optical device may include, for example, film and digital cameras, video cameras, monoculars, binoculars, telescopic (e.g., rifle) scopes, telescopes, etc. In the case of a camera, the lens cover 100 may be configured for attachment to the distal end of the lens of the camera to protect the frontmost element of the lens. For example, the lens cover 100 may include a threaded section that allows the lens cover 100 to be screwed onto the threaded filter ring of a lens barrel of a camera. Other attachment techniques are also possible including, for example, a friction fit, a magnetic attachment, and/or the like.

Some optical devices include a plurality of lenses that should be protected by a lens cover. For example, monoculars, binoculars, and telescopic scopes all generally include at least one ocular lens and at least one objective lens. To this extent, a lens cover 100 may be provided to protectively cover each of these lenses when such optical devices are not being used.

Referring again to FIGS. 1-6, according to embodiments of the disclosure, the lens cover 100 includes a rotatable actuating ring 102 and a plurality of flexible membranes 104. As shown in sequence in FIGS. 1, 3, and 5, the rotatable actuating ring 102 may be rotated in a first direction D1 to expand the flexible membranes 104 to fully close the lens cover 100 (e.g., to fully cover a lens 106 of an optical device). Conversely, as shown in sequence in FIGS. 6, 4, and 2, the rotatable actuating ring 102 may be rotated in a second, opposite direction D2 to contract the flexible membranes 104 to fully open the lens cover 100 (e.g., to fully expose the lens 106 of an optical device).

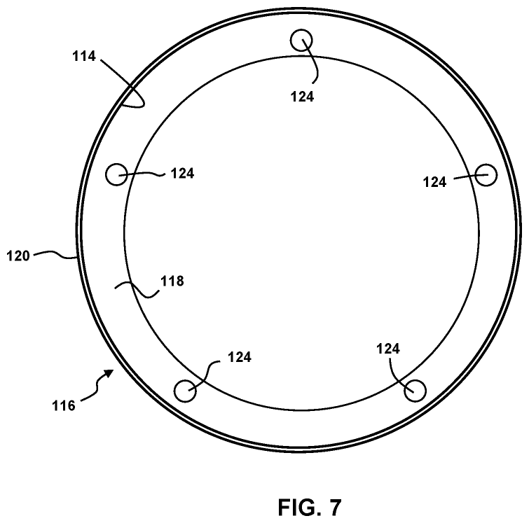

When the lens cover 100 is in a fully open state (FIGS. 1 and 2), each flexible membrane 104 is compressed between a strut 110 and an inner side surface 114 (FIGS. 7 and 10) of a base 116 of the lens cover 100. In the open state, the lens 106 of the optical device is fully exposed and is not blocked in any way by the flexible membranes 104 of the lens cover 100. When the lens cover 100 is in a transitional state (FIGS. 3 and 4), each flexible membrane 104 is partially expanded/contracted, leaving a portion of the lens 106 exposed. When the lens cover 100 is in the fully closed state (FIGS. 5 and 6), each flexible membrane 104 is fully expanded and covers a portion of the lens 106 between the rotatable actuating ring 102 and the corresponding strut 110 (e.g., ⅕ of the lens 106 in this embodiment). Together, in the closed state, the plurality of flexible membranes 104 completely cover and protect the lens 106 of the optical device.

As depicted in detail in FIG. 7, the base 116 of the lens cover 100 includes a bottom surface 118, an outer side surface 120, and an inner side surface 114. A plurality of posts 124 extend upward from the bottom surface 118 of the base 116 of the lens cover 100. According to embodiments, the number of posts 124 is equal to the number of flexible membranes 104 in the lens cover 100.

Referring to FIGS. 1-6 and 8, a bottom section 126 of each strut 110 includes an aperture 128 for receiving a respective one of the posts 124 extending upward from the bottom surface 118 of the base 116 of the lens cover 100. Each strut 110 is rotatably mounted on a respective post 124 via the aperture 128. The bottom section 126 of each strut 110 further includes a plurality of teeth 130 that are configured to engage a plurality of teeth 132 formed on an inner surface 134 of the rotatable actuating ring 102.

According to embodiments, each flexible membrane 104 may have a fan-shaped configuration that allows the flexible membrane 104 to expand and contract in response to a corresponding displacement of the strut 110 coupled to the flexible membrane 104. Each strut 110 is displaced by rotating the rotatable actuating ring 102 about the outer side surface 120 (FIGS. 7 and 10) of the base 116 of the lens cover 100. In response to a rotation of the rotatable actuating ring 102 in the first direction D1, the teeth 130 formed in the bottom section 126 of each strut 110 engage a corresponding set of the teeth 132 formed on the rotatable actuating ring 102. This causes each strut 110 to rotate about a respective post 124 in the first direction D1, thereby expanding the flexible membrane 104 over the lens 106 of the optical device. Conversely, a rotation of the rotatable actuating ring 102 in the second direction D2 causes each strut 110 to rotate about a respective post 124 in the second direction D2, thereby contracting the flexible membrane 104 and exposing the lens 106 of the optical device.

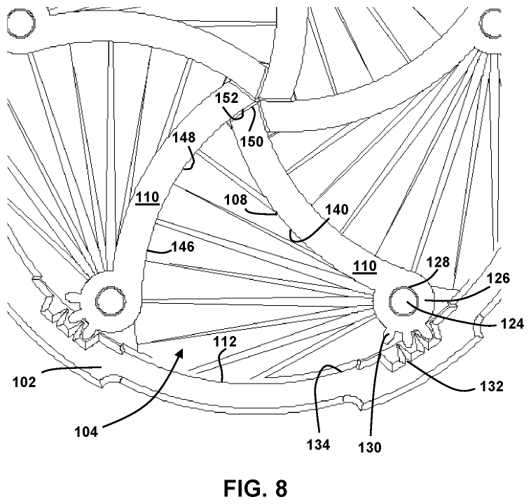

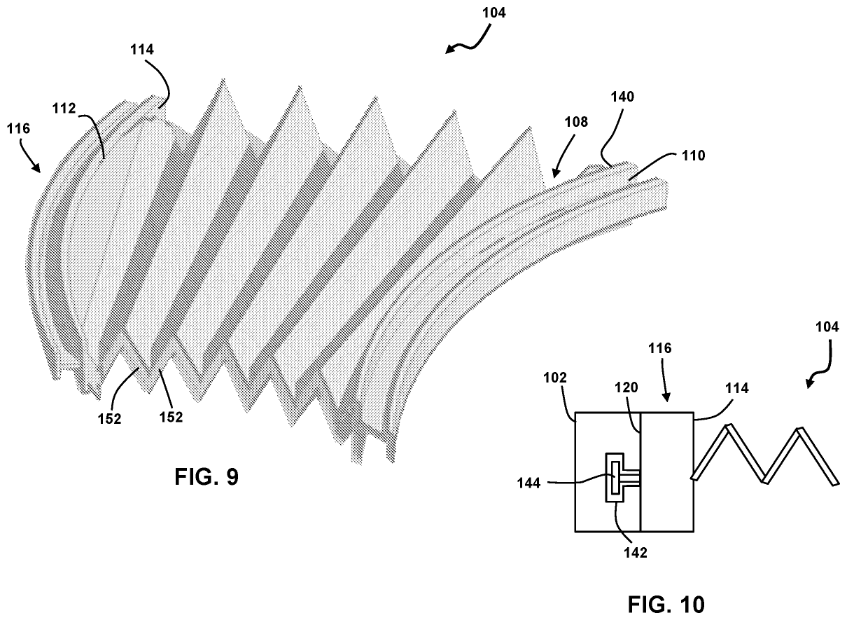

As shown in detail in FIGS. 8 and 9, a first side portion 108 of each flexible membrane 104 may be coupled to a convex side surface 140 of a strut 110. A second side portion 112 of each flexible membrane 104 may be coupled to the inner side surface 114 (FIG. 7) of the base 116 of the lens cover 100. A flexible membrane 104 may be coupled to a convex side surface 140 of strut 110 and the inner side surface 114 of the base 116 in any suitable manner. In some embodiments, the flexible membrane 104 and the strut 110 may be formed as a single unit (e.g., via 3-D printing, an extrusion process, etc.).

Referring to FIG. 10, the rotatable actuating ring 102 may include an aperture 142 that is configured to receive a complementary rail 144 coupled to and extending away from the outer side surface 120 of the base 116 of the lens cover 100. The aperture 142 allows the rotatable actuating ring 102 to be rotated along the rail 114 about the outer surface 120 of the base 116 in either direction, which causes the struts 110 to rotate about the posts 124 in the base 116 to expand/contract the flexible membranes 104 and selectively cover and uncover the lens 106 of an optical device.

As further shown in detail in FIG. 8, when expanded, each flexible membrane 104 includes a convex outer edge 146 that is configured to intersect and seal against a concave side surface 148 of an adjacent strut 110. In addition, a curved distal edge 150 of each strut 110 intersects with and is sealed against an end portion of the concave side surface 148 of an adjacent strut 110. In this manner, the lens 106 is fully covered and protected by the flexible membranes 104 when the lens cover 100 is in the closed state, preventing dust, water, or other contaminants from reaching or contacting the lens 106.

As detailed above, each flexible membrane 104 may have a fan-shaped configuration. For example, as depicted in FIG. 9, each flexible membrane 104 may include a plurality of panels 152 that are configured to fold against each other when the flexible membrane 104 is contracted and to fold away from each other when the flexible membrane 104 is expanded.

As disclosed herein, the lens cover 100 includes a combination of five flexible membranes 104. However, the lens cover 100 according to other embodiments may be implemented using a greater or lesser number of the flexible membranes 104. To this extent, the curvatures of the struts 110 and the flexible membranes 114 may be selected such that each flexible membrane 104 intersects with and seals against an adjacent strut 110 to fully cover and protect the lens 106 of an optical device.

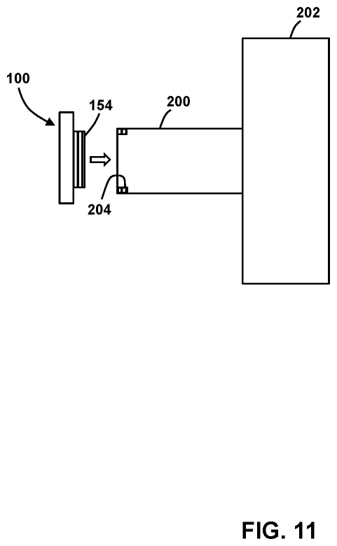

An attachment of the lens cover 100 to the end of a lens barrel 200 of an optical device 202 (e.g., a camera) according to embodiments is depicted in FIG. 11. As shown, the lens cover 100 may include a threaded section 154 extending away from the base 116. This allows the lens cover 100 to be screwed onto a threaded filter ring 204 formed on an interior surface of the lens barrel 200 of the optical device 202.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

1. A lens cover, comprising:
a plurality of flexible membranes;
a plurality of struts, wherein each strut is coupled to a respective flexible membrane of the plurality of membranes; and
a rotatable actuating ring for rotatably displacing the plurality of struts to expand or contract the plurality of flexible membranes to selectively cover or expose a lens of an optical device.

2. The lens cover according to claim 1, wherein each flexible membrane is fan shaped and includes a plurality of panels.

3. The lens cover according to claim 1, further including:
a base; and
a plurality of posts extending away from the base.

4. The lens cover according to claim 3, wherein each strut of the plurality of struts is rotatably mounted to a respective post of the plurality of posts.

5. The lens cover according to claim 4, wherein a section of each strut of the plurality of struts includes a plurality of teeth configured to engage a respective set of teeth formed about an inner surface of the base of the lens cover.

6. The lens cover according to claim 3, wherein the rotatable actuating ring is rotatably attached to an outer surface of the base of the lens cover.

7. The lens cover according to claim 1, wherein, when each flexible membrane is fully expanded, a convex outer edge of the flexible membrane is configured to intersect and seal against a concave side surface of an adjacent strut of the plurality of struts.

8. The lens cover according to claim 1, wherein, when each flexible membrane is fully contracted, the flexible membrane is compressed between its respective strut and an inner side surface of a base of the lens cover.

9. The lens cover according to claim 1, wherein a rotation of the rotatable actuating ring in a first direction expands the plurality of flexible membranes to cover the lens of the optical device, and wherein a rotation of the rotatable actuating ring in a second, opposite direction contracts the plurality of flexible membranes to expose the lens of the optical device.

10. An optical device, comprising:
a lens; and
a lens cover, wherein the lens cover includes:
a plurality of flexible membranes;
a plurality of struts, wherein each strut is coupled to a respective flexible membrane of the plurality of membranes; and
a rotatable actuating ring for rotatably displacing the plurality of struts to expand or contract the plurality of flexible membranes to selectively cover or expose the lens of the optical device.

11. The optical device according to claim 10, wherein each flexible membrane is fan shaped and includes a plurality of panels.

12. The optical device according to claim 10, wherein the lens cover further includes:
a base; and
a plurality of posts extending away from the base.

13. The optical device according to claim 12, wherein each strut of the plurality of struts is rotatably mounted to a respective post of the plurality of posts.

14. The optical device according to claim 12, wherein a section of each strut of the plurality of struts includes a plurality of teeth configured to engage a respective set of teeth formed about an inner surface of the base of the lens cover.

15. The optical device according to claim 12, wherein the rotatable actuating ring is rotatably attached to an outer surface of the base of the lens cover.

16. The optical device according to claim 10, wherein, when each flexible membrane is fully expanded, a convex outer edge of the flexible membrane is configured to intersect and seal against a concave side surface of an adjacent strut of the plurality of struts.

17. The optical device according to claim 10, wherein, when each flexible membrane is fully contracted, the flexible membrane is compressed between its respective strut and an inner side surface of a base of the lens cover.

18. The optical device according to claim 10, wherein a rotation of the rotatable actuating ring in a first direction expands the plurality of flexible membranes to cover the lens of the optical device, and wherein a rotation of the rotatable actuating ring in a second, opposite direction contracts the plurality of flexible membranes to expose the lens of the optical device.

19. The optical device according to claim 10, wherein the optical device comprises any one of a film camera, a digital camera, a video camera, a monocular, binoculars, a telescopic scope, and a telescope.

20. The optical device according to claim 10, wherein the lens cover further includes a threaded surface configured to be secured to a corresponding treaded surface of the lens of the optical device.
